(19) United States
(12) Patent Application Publication
(10) Pub. No.: US 2026/0285419 A1
(43) Pub. Date: Sep. 24, 2026

(54) Air guide device of a motor vehicle body

(71) Applicant: Dr. Ing. h.c. F. Porsche Aktiengesellschaft, Stuttgart (DE)

(72) Inventor: Pascal Tylla, Leonberg (DE)

(73) Assignee: Dr. Ing. h.c. F. Porsche Aktiengesellschaft, Stuttgart (DE)

(21) Appl. No.: 19/551,930

(22) Filed: Feb. 27, 2026

(30) Foreign Application Priority Data
Mar. 21, 2025 (DE) 10 2025 110 985.0

(51) Int. Cl. B62D 35/00; B62D 37/02

(52) U.S. Cl. CPC B62D 35/007; B62D 37/02

(57) ABSTRACT

An air-guiding device of a motor vehicle body has an air-guiding unit that is movable with the aid of an adjustment device relative to the motor vehicle body. The air-guiding unit can be brought from a rest position to at least a first work position and a second work position. The air-guiding unit includes a unit structure, which has a stiff first element part and a stiff second element part formed independently of the first element part that are connected by way of a third element part of the unit structure. The third element part is flexibly configured to move the first element part relative to the second element part. The third element part is uncurved in the first work position and has a curvature in the second work position.

### CROSS-REFERENCE TO RELATED APPLICATION

This application claims priority to German Patent Application No. 10 2025 110 985.0, filed March 21, 2025, the content of such application being incorporated by reference herein in its entirety.

### FIELD OF THE INVENTION

The invention relates to an air-guiding device of a motor vehicle body.

### BACKGROUND OF THE INVENTION

Air-guiding devices for motor vehicle bodies of motor vehicles comprising an air-guiding unit are known. The air-guiding units are so-called diffusors or also so-called rear wings that are movably received on the motor vehicle body so that they can assume different positions relative to the motor vehicle body between a first end position and a second end position. In particular, the air-guiding unit can be used to vary an output of the motor vehicle comprising the motor vehicle body during operation. The air-guiding unit is connected to an adjustment device of the air-guiding device, which moves the air-guiding unit in its corresponding position and holds it there.

An air-guiding device for a motor vehicle body in the form of a rear spoiler, which comprises an adjustable inner part, is known from the disclosure document DE 10 2019 115 338 A1, which is incorporated by reference herein. When the inner part is installed, a surface covering the inner part is bent upwards.

DE 10 2021 112 769 A1, which is incorporated by reference herein, discloses an air-guiding device for a motor vehicle body, which has a linkage that can be moved to set up the rear spoiler. An elastic base body is arranged on the linkage, which comprises an elastic textile fabric that extends beyond the base body.

DE 10 2020 116 613 B3, which is incorporated by reference herein, describes an air-guiding device for a motor vehicle body, with an elastic base element and an actuator device, wherein the base element is connected to the actuator device at its lower side, and is moved translationally and with a self-rotation with the aid of the actuator device. A support cable is attached to a top side of the base element, which is fixed to the body at its end facing away from the base element. The support cable is a modification of the base element, which can be moved rearward and upward and is designed to provide support.

### SUMMARY OF THE INVENTION

An air-guiding device according to aspects of the invention, wherein an air-guiding unit of the air-guiding device can be moved relative to the motor vehicle body with the aid of an adjustment device and can be brought from a rest position to at least a first work position and a second work position. According to aspects of the invention, the air-guiding unit comprises a unit structure, which comprises a stiff first element part and a stiff second element part formed independently of the first element part, connected by means of a third element part of the unit structure, wherein the third element part is flexibly configured to move the first element part relative to the second element part, and wherein the third element part is uncurved in the first work position, and has a curvature in the second work position. The curvature corresponds to a convex curvature formed relative to the motor vehicle body. This means that the unit structure is only partially bendable and reversibly deformable in order to bring about an engagement position of the air-guiding unit which produces an output. The advantage of the invention can be seen in that the third element part can be used for the adjustment of the air-guiding unit due to its flexibility and a simple and inexpensive adjustment device can be configured.

If the third element part is a spring plate, the third element part may be manufactured inexpensively. Furthermore, flexibility can be ensured as the spring plate is not elastic and, therefore, not stretchable. Thus, a horizontal arrangement of the first element part and the second element part can be used to bring about a reversible adjustment of the first element part relative to the second element part.

In order to ensure sufficient movement of the first element part and the second element part relative to one another, the first element part and the second element part are spaced apart from one another along a longitudinal axis of the air-guiding unit, with a distance between them. This distance is bridged with the aid of the third element part, wherein a gap formed by the distance does not necessarily have to be filled in completely by the third element part.

The adjustment device has a retaining element which is connected to the first element part in an economical way and exerts a pulling force on the first element part when the air-guiding unit is adjusted, wherein the retaining element is in particular in the form of a draw band.

To securely move the air-guiding unit from the first work position to the second work position and to stably position the air-guiding unit in the second work position, the retaining element is fixedly attached to the first element part at its first end and is attached to the body at its second end facing away from the first end.

A cost-effective air-guiding device can be realized if the air-guiding unit comprises a sheath in the form of a textile jacket, which is configured to encompass at least the first element part, the second element part, and the third element part.

If the first element part and/or the second element part and/or the adjustment device are at least partially made of a fiber composite, the air-guiding device can be configured in a lightweight design.

Preferably, the air-guiding device is configured in the form of a rear spoiler and/or a diffuser, a so-called rear diffuser. The term “diffuser” also refers to small diffusers on an underbody of the motor vehicle body, which serves to cool disc brakes in particular.

### BRIEF DESCRIPTION OF THE INVENTION

Additional advantages, features, and details of the invention arise from the following description of preferred exemplary embodiments, as well as with reference to the drawings. The features and feature combinations specified hereinabove in the description, as well as the features and feature combinations mentioned hereinafter in the description of the drawings and/or shown alone in the drawings, can be used not only in the respectively specified combination, but also in other combinations, or on their own, without departing from the scope of the invention. Identical or functionally identical elements are assigned identical reference signs. The figures show:

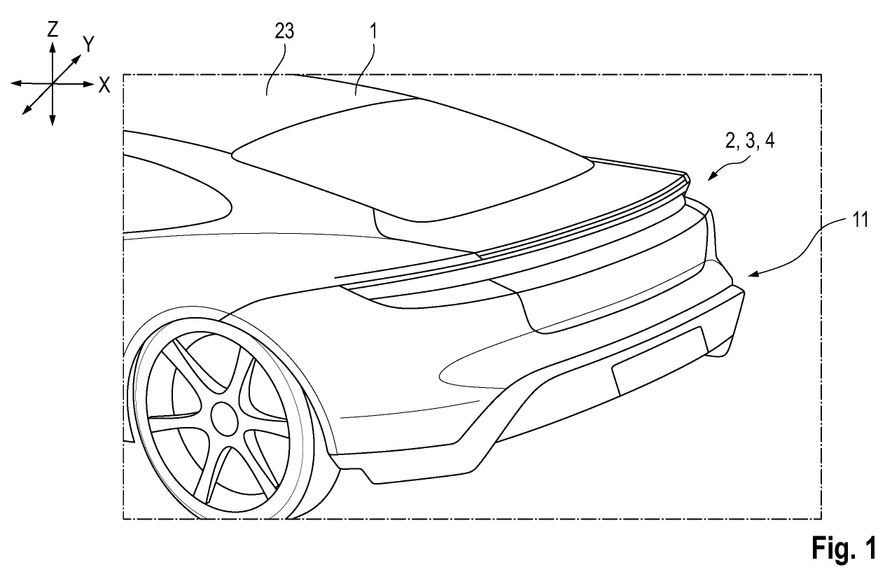

FIG. 1 in a section, a motor vehicle body with an air-guiding device according to aspects of the invention, wherein an air-guiding unit of the air-guiding device is arranged in a rest position,

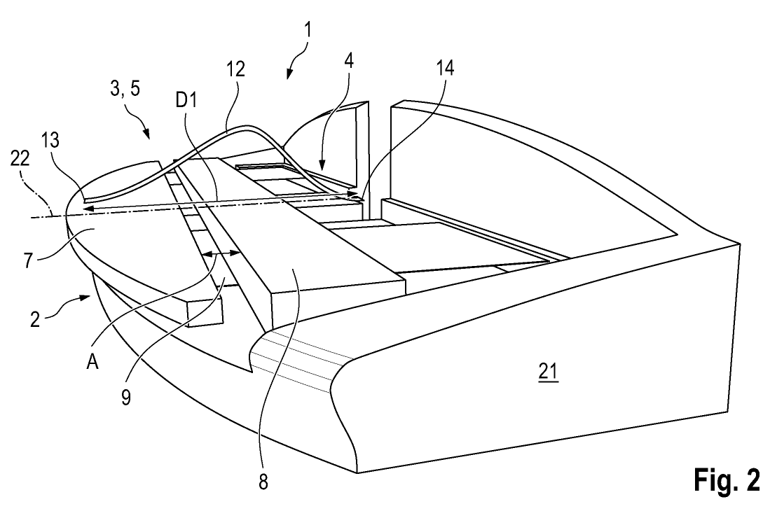

FIG. 2 in a perspective view, a unit structure of the air-guiding device according to aspects of the invention,

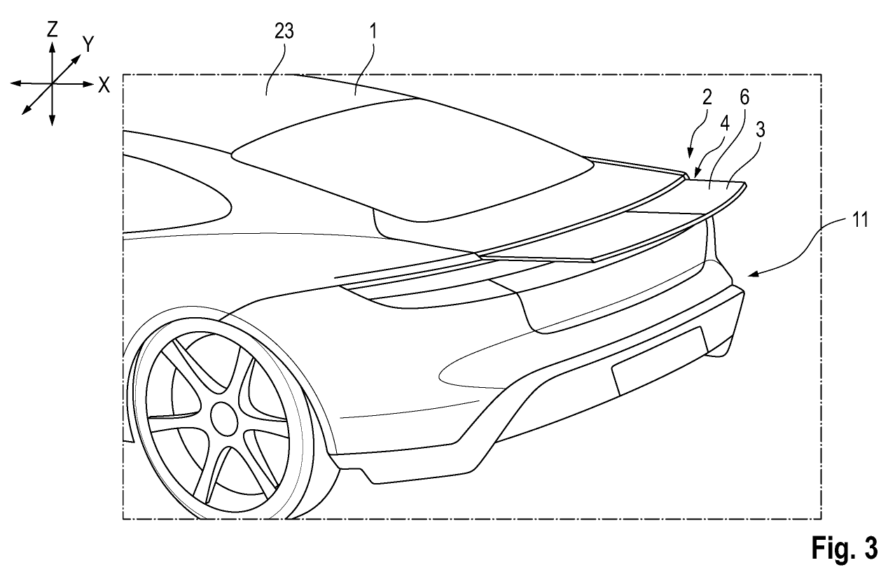

FIG. 3 in a section, the motor vehicle body with the air-guiding device according to aspects of the invention, wherein the air-guiding unit is arranged in a first work position,

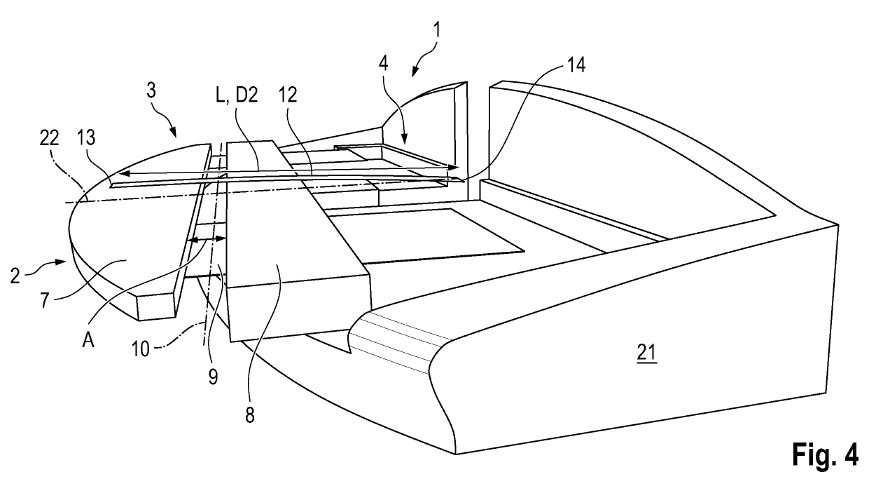

FIG. 4 in a perspective view, the unit structure of the air-guiding device according to aspects of the invention in the first work position,

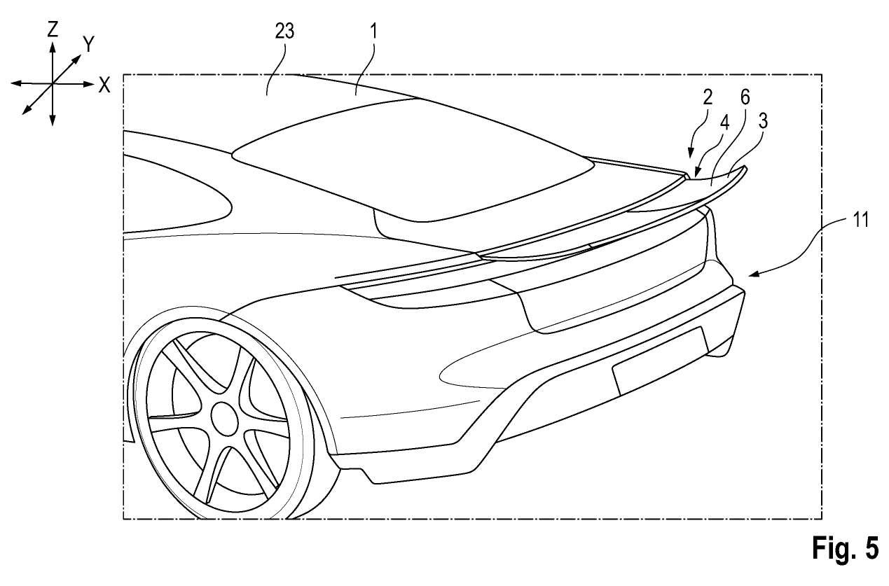

FIG. 5 in a section, the motor vehicle body with the air-guiding device according to aspects of the invention, wherein the air-guiding unit is arranged in a second work position,

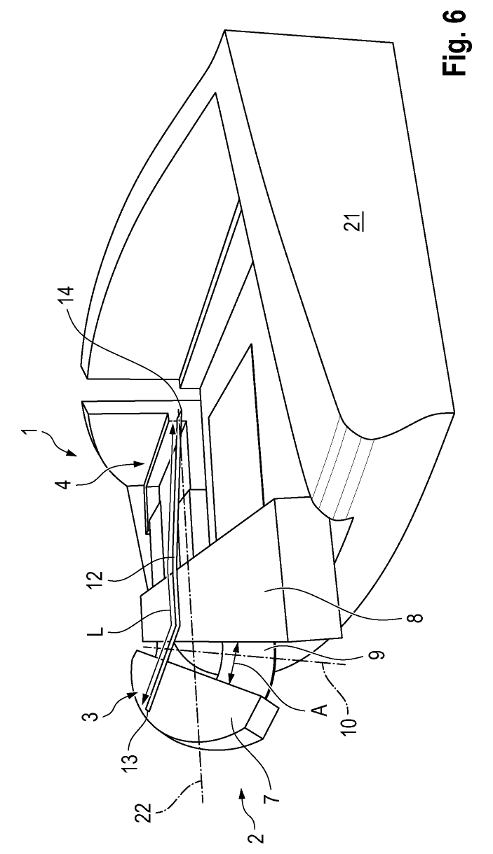

FIG. 6 in a perspective view, the unit structure of the air-guiding device according to aspects of the invention in the second work position, and

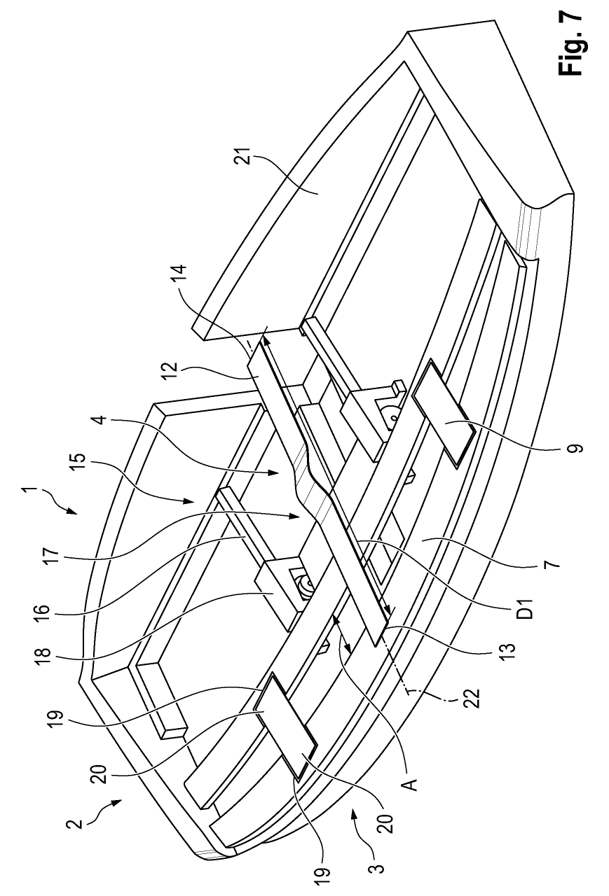

FIG. 7 in a further perspective view, the unit structure device of the air-guiding device according to aspects of the invention in the rest position.

### DETAILED DESCRIPTION OF THE INVENTION

FIG. 1 shows, in a section, a motor vehicle body 1 with an air-guiding device 2 according to aspects of the invention, wherein an air-guiding unit 3 of the air-guiding device 2 is arranged in its rest position. With the aid of an adjustment device 4, the air-guiding unit 3 is movably received in the motor vehicle body 1. In this exemplary embodiment, the air-guiding device 2 is designed in the form of a rear spoiler, wherein the air-guiding unit 3 forms a spoiler element that is subject to the air flow, along which the air flow is aligned.

The adjustment device 4 is configured to move the air-guiding unit 3, which can be brought into different positions with the aid of the adjustment device 4. The different positions include a rest position, in which the air-guiding unit 3 is completely accommodated in the vehicle body 1, or at least does not generate any or significant output, and work positions, in which the air-guiding unit 3 adjusted to generate output.

In FIG. 2 in a perspective illustration, a unit structure 5 of the air-guiding device 2 according to aspects of the invention is illustrated in the rest position. The unit structure 5 is associated with the air-guiding unit 3 and represents its base structure. When the air-guiding device 2 is installed in the motor vehicle body 1, the uniform structure 5 is encased in a jacket 6, which is preferably a textile jacket and is therefore flexible.

The unit structure 5 is formed from a first element part 7, a second element part 8, and a third element part 9 connecting the first element part 7 to the second element part 8. A distance A is formed between the first element part 7 and the second element part 8, which is bridged at least in sections with the aid of the third element part 9, such that a connection between the first element part 7 and the second element part 8 is formed with the aid of the third element part 9.

The distance A is at least so great that a movement of the first element part 7 relative to the second element part 8 can be realized, wherein the movement of the first element part 7 is a pivoting movement about a pivot axis 10, which is brought about with the aid of the adjustment device 4.

Starting from the rest position illustrated in FIGS. 1 and 2, the air-guiding unit 3, comprising the unit structure 5 and the jacket 6, is moved in a translational movement, which is essentially a horizontal movement, from the rest position to the first work position, which is shown in FIGS. 3 and 4. In other words, the air unit 3 is moved out of the motor vehicle body 1 along a body longitudinal axis X of the motor vehicle body 1, in particular beyond a rear end 11 of the motor vehicle body 1. For improved understanding, a Cartesian coordinate system is introduced, having extension directions of axes of the motor vehicle body 1, the body longitudinal axis X, a body transverse axis Y, and a body vertical axis Z.

Starting from the first work position, the air-guiding unit 3 can be brought to its second work position, wherein the pivoting movement follows the translational movement. The air-guiding unit 3 is illustrated in its second work position in FIGS. 5 and 6.

To bring about the pivoting movement, the adjustment device 4 comprises a non-elastic retaining element 12, which is designed in the form of a band and which is fixedly connected to the first element part 7 on its first end 13 facing the first element part 7.

The retaining element 12, which is not elastic and therefore not stretchable, has a total length L between its first end 13 and its second end 14, which is located away from the first end 13 and is fixed to the car body, which total length L is greater than a first distance D1 between the first end 13 and the second end 14 in the rest position. From the rest position, the air-guiding unit 3 is brought to the first work position, wherein a second distance D2 is now formed between the first end 13 and the second end 14, which corresponds to the overall length L. The retaining element 12 is tensioned in the first work position. In a further translational movement of the at least second element part 8, the first element part 7 is pulled upwardly with the aid of the retaining element 12, thus along the body vertical axis Z towards a roof 23 of the motor vehicle body 1 and thus pivoted about the pivot axis 10. In other words, the air-guiding unit 3 is moved further back from the first work position than the length of the retaining element 12, so that the first element part 7 is raised by a pulling force of the retaining element 12 to bring about a desired output.

The third element part 9 connecting the first element part 7 and the second element part 8, the two element parts 7, 8, is elastic and preferably designed in the form of a spring plate. Thus, the air-guiding unit 3 also has a stable contour in the second work position. If the air-guiding unit 3 is returned to the first work position from the second work position, the retaining element 12 is relaxed again and the first element part 7 is again pivoted downwardly with the aid of the third element part 9 to its position corresponding to the first work position. From this first work position, the air-guiding unit 3 can be brought back to the rest position.

In FIG. 7, the air-guiding unit 3 and the adjustment device 4 are illustrated at least in part in a further perspective representation in the rest position. The adjustment device 4 comprises a linear unit 15 for the translational movement of the unit structure 5, which in the present exemplary embodiment has two rail elements 16, wherein a drive 17 of the adjustment device 4 can be moved relative to the two immovably configured rail elements 16 along its longitudinal extension. For this purpose, the drive 17 has a carriage 18 for each of the two rail elements 16, which is connected to the rail element 16 and can move relative to it, and which can move in a translational manner on the rail element 16. The drive 17 is fixedly connected to the second element part 8. This is advantageous for a fast and exact movement of the unit structure 5 and thus the air-guiding unit 3.

The retaining element 12 is fixedly attached to the first element part 7 at its first end 13 and to the body at its second end 14.

For the preferred connection of the third element part 9 to the first element part 7 and the second element part 8, the two element parts 7, 8 each comprise an oppositely formed groove 19, into which a partial end 20 of the third element part 9 is arranged. To secure the connection, the third element part 9 can be connected to the two element parts 7, 8 in a positive and/or form fit and/or in a materially bonded manner.

In the present example embodiment, the unit structure 5 and the adjustment device 4 are housed in a housing 21, which is rigidly connectable to the motor vehicle body 1, wherein the unit structure 5 and the drive 17 can move relative to the housing 21. The air-guiding device 2 can thus be configured in the form of a module, which is inserted into the motor vehicle body 1. Likewise, the housing 21 could be part of the motor vehicle body 1, and thus form a section of the motor vehicle body 1.

The air-guiding unit 3 is usually located in the second work position insofar as an output is necessary, since it is used to bring about an output. The generation of a corresponding output is necessary, for example, during braking, in particular from high speeds and/or when cornering, in particular at high speeds, in order to stabilize the driving behavior of the motor vehicle body 1. In other words, during or just prior to the braking operation to bring about a high output, the air-guiding unit 3 is placed in the second work position or in another work position formed between the first work position and the second work position.

The air-guiding unit 3 is in its first work position, in particular when a high speed is desired without the need for an output, e.g., when driving in a straight line, and can be used to prevent exceeding a maximum tire load. Of course, the air-guiding unit 3 can be arranged in different intermediate positions between the rest position and the first work position.

### LIST OF REFERENCE SIGNS

1 Motor vehicle body

2 Air-guiding device

3 Air-guiding unit

4 Adjustment device

5 Unit structure

6 Sheath

7 First element part

8 Second element part

9 Third element part

10 Pivot axis

11 Rear

12 Retaining element

13 First end

14 Second end

15 Linear unit

16 Rail element

17 Drive

18 Carriage

19 Groove

20 Part end

21 Housing

22 Longitudinal axis

23 Roof

A Distance

D1 First distance

D2 Second distance

L Total length

X Body longitudinal axis

Y Body transverse axis

Z Body vertical axis

What is claimed is:

1. An air-guiding device of a motor vehicle body, said air-guiding device comprising:
an air-guiding unit that is moveable relative to the motor vehicle body by way of an adjustment device and is configured to be moved from a rest position to at least a first work position and a second work position,
wherein the air-guiding unit comprises a unit structure including a stiff first element part, a stiff second element part formed independently of the first element part, and a third element part connecting the stiff first element part to the stiff second element part,
wherein the third element part is flexibly configured to move the first element part relative to the second element part, and
wherein the third element part is uncurved in the first work position and has a curvature in the second work position.

2. The air-guiding device according to claim 1, wherein the third element part is a spring plate.

3. The air-guiding device according to claim 1, wherein the first element part and the second element part are arranged along a longitudinal axis of the air-guiding unit and spaced apart from one another along the longitudinal axis by a distance (A).

4. The air-guiding device according to claim 1, wherein the adjustment device comprises a retaining element which is connected to the first element part and exerts a pulling force on the first element part when the air-guiding unit is adjusted.

5. The air-guiding device according to claim 4, wherein the retaining element is a draw band.

6. The air-guiding device according to claim 4, wherein the retaining element has a first end that is fixedly connected to the first element part and a second end, which faces away from the first end, that is fixedly connected to the motor vehicle body.

7. The air-guiding device according to claim 1, wherein the air-guiding unit comprises a sheath in the form of a textile jacket, which sheath encompasses at least the first element part, the second element part, and the third element part.

8. The air-guiding device according to claim 1, wherein the first element part and/or the second element part and/or the adjustment device are at least partially composed of a fibrous composite.

9. The air-guiding device according to claim 1, wherein the air-guiding device is a rear spoiler.

10. The air-guiding device according to claim 1, wherein the air-guiding device is a diffuser.

11. The air-guiding device according to claim 1, wherein the air-guiding device is a rear spoiler and a diffuser.

12. A motor vehicle comprising the air-guiding device of claim 1.
